(19) United States
(12) Patent Application Publication
(10) Pub. No.: US 2003/0146224 A1
(43) Pub. Date: Aug. 7, 2003

(54) Heat insulating container

(76) Inventors: Takafumi Fujii, Nishikanbara-gun (JP); Eiji Otsuka, Shanghai (CN)

Correspondence Address: BURNS DOANE SWECKER & MATHIS L L P, POST OFFICE BOX 1404, ALEXANDRIA, VA, 22313-1404, US

(21) Appl. No.: 10/257,492

(22) PCT Filed: Apr. 3, 2001
(86) PCT No.: PCT/JP01/02886

(51) Int. Cl. A47J 39/00; A47J 41/00; B65D 81/38; B65D 83/72

(52) U.S. Cl. 220/592.27

(57) ABSTRACT

A heat insulating container having its outer surface formed of a synthetic resin such as a vacuum bottle, a cooler box, an ice box, a heat insulating cup, a heat retaining lunch box, and a heat insulating and retaining storage container capable of preventing problems such as a small available volume compared with a relatively large outer size so as to provide an increased insulating effect, corrosion of metallic containers, and inefficient washing of synthetic resin containers because the containers float in a water bath when washing; the heat insulating container having a metallic inner wall member 2 and a metallic outer wall member 3 disposed with a space portion 4 between them, the opening end portions 2a, 3a of these wall bodies being formed integrally with each other, and at least one of the inner and outer surfaces of a heat insulating layer body 1 formed by evacuating the space part 4 being covered by a synthetic resin inside container part 11 or an outside container part 12 and formed integrally with the heat insulating layer body so as to increase the specific gravity of the heat insulating container.

### TECHNICAL FIELD

The present invention relates to a heat insulating container which may be applicable to, for instance, a vacuum bottle, a cooler box, an ice box, a heat insulating cup, a heat retaining lunch box, and a heat insulating and retaining storage container.

This application is based on Patent Application to the country of Japan (Japanese Patent Application No. 2000-110828), the content of which is incorporated herein by reference.

### BACKGROUND ART

Heat insulating containers made of metal or synthetic resins have been developed and manufactured for vacuum bottles, cooler boxes, ice boxes, heat insulating cups, heat retaining lunch boxes, heat insulating and retaining storage containers, and so forth because of their light weight, ease of molding, and low material and manufacturing costs.

Among the above, for heat insulating containers made of a synthetic resin, an inside container made of a synthetic resin is disposed in an outside container, which is also made of a synthetic resin and has a similar shape to the inside container but with a larger size, with a space between the two, and the ends of an opening portion of the inside container and the outside container are uniformly joined to form a double-walled structure. The space is filled with a heat insulating medium to form a heat insulating layer. Examples of the heat insulating medium include, for instance, air, a gas having thermal conductivity smaller than that of air, such as krypton gas, xenon gas, and argon gas, and a urethane foaming material, and the medium may be suitably selected in accordance with the heat insulating performance required for a particular heat insulating container.

In the above-mentioned heat insulating container made of a synthetic resin, the inside and the outside containers are required to have a thickness of 2 mm or more in terms of the required strength. Also, the width of the heat insulating layer, i.e., the width of the space between the inside container and the outside container, is required to be 10-20 mm. These cause a problem of imparting to the user an impression of a small available volume (i.e., the available space is small relative to apparent size of the container).

Moreover, when the above-mentioned heat insulating container made of a synthetic resin having an insulating layer in which air or a gas having a low thermal conductivity is sealed as a heat insulating medium, is washed using, for instance, hot water, the air or gas expands due to the heat, and this causes deformation of the inner and outer containers making the heat insulating container unusable. This problem of deformation stands out in particular when heat insulating containers for business use are washed using hot water, and then dried to be sterilized at high temperature.

Furthermore, when a large number of such heat insulating containers are washed, the containers to be washed are often immersed in a washing bath. However, because the specific gravity of these containers is smaller than 1, the containers float on the water, and hence, it is difficult to remove food or drink stains on container walls. Accordingly, it is necessary to wash the heat insulating container in the washing bath one by one by hand, and then wash them again using an automated washer. This lowers the efficiency of the washing operation. For this reason, in order to carry out the washing operation for the above-mentioned heat insulating containers made of a synthetic resin, it is necessary, for example, to cover the whole washing bath using a metal cover and to place a weight on the cover, or to place the heat insulating containers in a metal basket provided with a cover, to which a weight is attached, and forcibly immerse the metal cover or the basket in the washing bath.

In a heat insulating container made of a metal, on the other hand, which uses a metallic material, such as a stainless steel, for its inside and outside containers, similar to the structure of the above-mentioned heat insulating container made of a synthetic resin, the inside container made of a metal is disposed in an outside container, which is also made of a metal and has a similar shape to the inside container but with a larger size, with space between the two, and the ends of the opening portion of the inside container and the outside container are uniformly joined by welding, for instance, to form a double-walled structure. The space is filled with a heat insulating medium to form a heat insulating layer. Examples of the heat insulating medium include, for instance, a heat insulating material, and a gas having small thermal conductivity. It is possible to make the space a vacuum, to function as a heat insulating layer. The medium may be suitably selected in accordance with the heat insulating performance required for a particular heat insulating container. Especially, since it is possible to make the width of the space 2 mm or 3 mm for a vacuumed insulating layer provided in the vacuum heat insulating container, the structure thereof may be made compact, and a structure including a vacuum heat insulating layer can be suitably used for a heat insulating container.

However, in a heat insulating container made of a metal, the thickness of the inside container and that of the outside container need to be about 0.6 mm, taking into account the shocks occurring when the container is dropped or when an external shock is applied. For the heat insulating container having a vacuum heat insulating layer, in particular, since container walls are always subject to atmospheric pressure, the container is required to have a thickness of 0.6 mm or more, otherwise buckling tends to occur when the container is dropped, and the container becomes practically unusable. Moreover, since the container is made of a metal, which has a high thermal conductivity, a larger amount of heat in the heat insulating container tends to escape to the outside, as compared with a heat insulating container made of a synthetic resin, from an opening portion thereof which is exposed to the outside. Accordingly, if the thickness of the container is increased in order to obtain a certain strength, the amount of heat loss is also increased as the thickness of the container increases, and hence the heat insulating performance thereof is reduced. Therefore, if a heat insulating container made of a metal with a large opening portion is manufactured using a vacuum heat insulating structure, the manufacturing will be high with respect to its heat insulating performance, and the product would have no value as a commercial product due to the imbalance between its performance and its costs.

Also, when the heat insulating container made of a metal is used for holding a hot food or drink, the opening portion of the container is heated by the food or drink, and the user of the container cannot put his mouth directly to the container to intake the food or drink.

Moreover, if the container is used to serve a liquid containing a large amount of salt, such as miso soup, for a long period of time, a problem arises in that the surface of the container may rust due to contact with the miso soup.

Furthermore, when the container is washed after use with, for instance, hot water, the container as a whole is heated, and it is very inconvenient to handle the container after washing.

In addition, when the above-mentioned heat insulating containers made of a metal are manufactured as tableware, such as cups and bowls, the containers tend not to be readily accepted by users, compared with ordinary tableware, due to their less favorable appearance.

### DISCLOSURE OF INVENTION

The present invention has been achieved in consideration of the above, and its object includes to provide a heat insulating container, which is excellent in heat insulating performance and available volumetric space efficiency, and which makes the washing process using a washing bath efficient by not floating on the bath water.

The heat insulating container of the present invention includes: a heat insulating layer body which is formed by a metallic inner wall member having a container shape, and a metallic outer wall member having a container shape, an end portion of the inner wall member and an end portion of the outer wall member being integrally bonded so as to provide a vacuum space portion between the inner wall member and the outer wall member; and a synthetic resin which covers at least one of an inner surface and an outer surface of the heat insulating layer body and which is integrated with the heat insulating layer body.

Also, the heat insulating container of the present invention may have a structure with the above-mentioned characteristics, wherein the synthetic resin, which covers at least one of the inner surface and the outer surface of the metallic heat insulating layer body, and is integrated with the heat insulating layer body, covers both the inner surface and the outer surface of the metallic heat insulating layer body, and bonds each end portion thereof in an air tight manner.

Also, the heat insulating container of the present invention may have a structure with the above-mentioned characteristics, wherein the synthetic resin, which covers at least one of the inner surface and the outer surface of the metallic heat insulating layer body, and is integrated with the heat insulating layer body, is formed on at least one of the inner surface and the outer surface of the heat insulating layer body using an insertion molding method.

Also, it is preferable that the heat insulating container of the present invention has a structure with the above-mentioned characteristics, wherein the specific gravity of the heat insulating container is 1 or more.

Also, the heat insulating container of the present invention may have a structure with the above-mentioned characteristics, wherein the width of the space portion of the heat insulating layer body is 4 mm or less.

Also, the heat insulating container of the present invention may have a structure with the above-mentioned characteristics, wherein the thickness of an opening portion of the inner wall member of the heat insulating layer body is 0.3 mm or less.

Also, the heat insulating container of the present invention may have a structure with the above-mentioned characteristics, further comprising a multi-bent stepped portion provided at the inner wall member of the heat insulating layer body facing an opening portion of an inside container part of the heat insulating container.

Also, the heat insulating container of the present invention may have a structure with the above-mentioned characteristics, wherein the length of a wall forming the stepped portion of the inner wall member of the heat insulating layer body facing the opening portion of the inside container part of the heat insulating container is 20 mm or longer.

Also, the heat insulating container of the present invention may have a structure with. the above-mentioned characteristics, and further comprises a concave portion provided at the opening portion of the inside container part of the heat insulating container, the concave portion being formed so as to retract towards the heat insulating layer side.

### BRIEF DESCRIPTION OF THE DRAWINGS

FIG. 1 is a diagram showing a partial cross-sectional view of a heat insulating container according to an embodiment of the present invention.

FIG. 2 is a diagram showing a partial cross-sectional view of a cup type heat insulating container according to another embodiment of the present invention.

FIG. 3 is a diagram showing a cross-sectional view for explaining a heat insulating and retaining storage container according to a fourth embodiment.

### BEST MODE FOR CARRYING OUT THE INVENTION

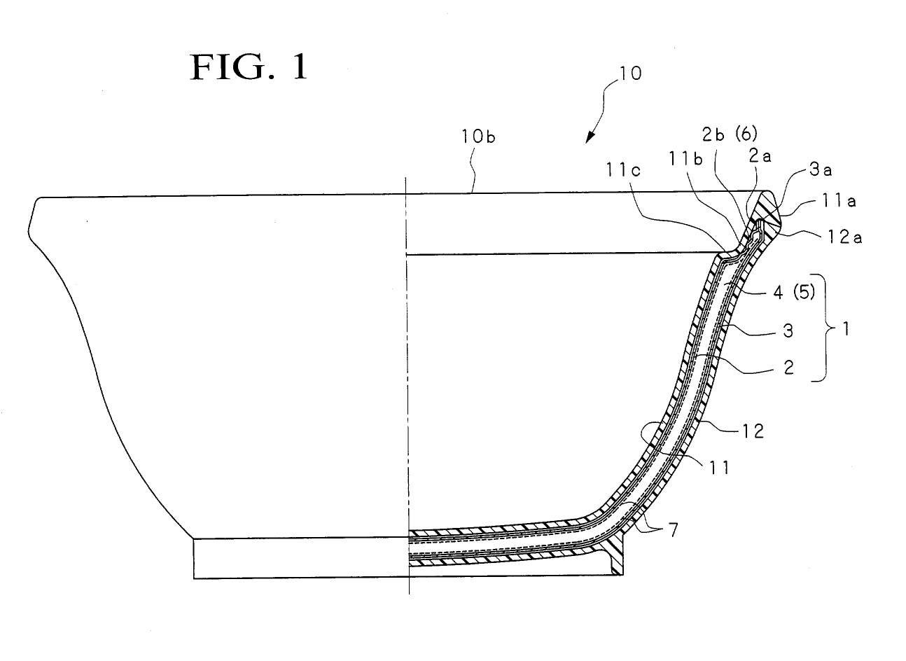

Hereinafter, heat insulating containers according to embodiments of the present invention will be described with reference to the attached drawings. FIG. 1 is a diagram showing a partial cross-sectional view of a heat insulating container according to an embodiment of the present invention.

The heat insulating container 10 of the present invention includes a heat insulating layer body 1 made of a metal having a container shape of a double-walled structure (hereinafter called a “heat insulating layer body”), and an inside container part 11, and an outside container part 12, both of which are made of a resin and disposed so as to cover the inner surface and the outer surface, respectively, of the heat insulating layer body 1. Opening end portions 11a and 12a of the inside container part 11 and an outside container part 12, respectively, are integrally joined to be airtight.

Also, in another embodiment of the present invention, it is possible to adapt a so-called insert molding process in which a heat insulating layer body 1 made in advance using a metal is placed at a predetermined position of a die for a synthetic resin having a predetermined shape, and a synthetic resin is introduced to at least one of the inner surface and the outer surface of the heat insulating layer body 1 so that the synthetic resin makes close contact with the heat insulating layer body 1 to be unified with the heat insulating layer body 1.

The above-mentioned heat insulating layer body 1 includes a metallic inner wall member 2 in a container shape (hereinafter abbreviated as an “inner wall member”) made of, for instance, a stainless steel, and a metallic outer wall member 3 in a container shape (hereinafter abbreviated as an “outer wall member”) made of, for instance, a stainless steel. The metallic inner wall member 2 and the metallic outer wall member 3 are separated by a space portion 4, and opening end portion 2a and 3a of the metallic inner wall member 2 and the metallic outer wall member 3, respectively, are integrally formed by, for instance, welding. The space portion 4 is evacuated to generate a vacuum space 5. Note that the thickness of the inner wall member 2 and the outer wall member 3, are each 0.3 mm or less to withstand the atmospheric pressure once the vacuum is generated, and in consideration of reducing heat transfer loss from the opening end portions 2a and 3a. Using the above thickness, makes it possible to temporarily absorb external forces that may be applied in an assembly operation in which the heat insulating layer body 1 is covered by the inside container part 11 and the outside container part 12 and is integrally formed. Accordingly, the workability of the container can be significantly improved.

Also, if the width of the space portion 4, which forms the vacuum space 5, is 4 mm or less, the width is sufficient for effectively providing heat insulating performance. Moreover, the available volumetric efficiency may be improved due to the decreased thickness of the heat insulating layer.

Furthermore, the size of the opening portion 2b of the inner wall member 2 may be increased for an opening portion 11b of the inside container part 11, to form a stepped portion 6, which bends in an up-and-down direction, at a position facing a wall surface of the opening portion 11b located above a concave portion 11c which is formed so as to retract towards the heat insulating layer side. In this manner, the path for transmitting heat at the opening portion 2b of the inner wall member 2, from which heat enters and exits, is lengthened, to decrease heat transfer loss, and the heat retaining property of the heat insulating container 10 can be improved. It is preferable that the above-mentioned stepped portion 6, which lengthens the heat transfer path, be positioned at a contacting portion or above the contacting portion of, for instance, a cover which covers the opening portion 10b of the heat insulating container 10, and that the length of the heat transfer path be 20 mm or longer. In addition, the structure of the stepped portion 6 serves the function of absorbing external forces applied during the integrating welding process as well as increasing the heat transfer path.

Also, by providing a radiation preventing layer 7 including a metal layer or metal foil of, for instance, copper and aluminum, on the surface of the inner wall member 2 and that of the outer wall member 3 facing the space portion 4, it becomes possible to further improve the heat insulating property of the heat insulating layer body 1.

It is preferable to use a synthetic resin having an excellent heat-resistance, moisture-resistance (vapor transmission resistance), and mechanical strength for the above-mentioned inside container part 11, which covers the inner wall member 2, and for the outside container part 12, which covers the outer wall member 3 of the heat insulating layer body 1. It is preferable that the synthetic resin have a vapor transmission ratio, based on “JIS Z 0280”, of 50 g/m²/24 hr or less under the conditions of a temperature of 40° C. and a relative humidity of 90%, a bending modulus ratio, based on “ASTM M D790”, of 10,000 kg/cm² or more, and/or Izod impact strength (with a notch) of 20 J/m or more. Examples of the synthetic resins which satisfy the above conditions and which may be used in the present invention, include, for instance, polypropylene, ABS, and polycarbonate.

The above-mentioned synthetic resin has a low adsorption property and excellent chemical resistance, and hence the problem of transfer of odors can be significantly reduced if the container is applied to tableware, cooler boxes, mugs, and so forth. Also, since the synthetic resin is applied to the outer surface of the container, it is easy to apply a design to the container by printing, for instance.

The heat insulating container 10 of the present invention explained above includes the evacuated heat insulating layer body 1 made of a metal, and the heat insulating layer body 1 is covered by the inside container part 11 made of a synthetic resin and the outside container part 12 also made of a synthetic resin and integrally formed. Accordingly, even if a metal having a decreased thickness with a large heat conductivity ratio is used for the heat insulating layer body 1, the strength of the heat insulating layer body 1 is not adversely affected. Therefore, the size of the space portion 4 of the heat insulating layer 5, which forms the heat insulating layer body 1, can be decreased to increase the available volumetric space ratio. Accordingly, the heat retaining property of the container can be improved.

Also, since the heat insulating layer body 1 is made of a metal, it becomes possible to increase the specific gravity of the heat insulating container 10 to 1 or more. Accordingly, the container does not float on the water when it is placed in a washing bath during a washing process, and can be immersed in the water as desired. Therefore, it is possible to carry out the washing process for the containers using an automated washer, and so forth.

Note that the above-mentioned integration of the inside container part 2 with the outside container part 12, which cover the heat insulating layer body 1, at the end portions thereof can be performed using a welding method or a screwing method.

Next, a method for manufacturing the above-mentioned heat insulating container according to the present invention will be explained.

Forming-Processing Process

First, the inner wall member 2, and the outer wall member 3, which are made of a metal, such as a stainless steel, and the inside container part 11 and the outside container part 12, which are made of a synthetic resin, respectively, are formed so that the container has the desired shape and size. At this stage, a hole used for evacuation (not shown in the figures) is formed in the metallic outer wall member 3. Also, the multi-bent stepped portion 6 is formed with the metallic inner wall member 2 in order to increase the length of the opening portion 2b. Moreover, the radiation preventing layer 7 made of a metal plating or metal foil of, for instance, copper and aluminum, is disposed on the surface of the inner wall member 2 and optionally on the outer wall member 3 facing the space portion 4.

Forming Process for the Heat Insulating Layer Body 1

The shape of the inner wall member 2 is matched with that of the outer wall member 3, and the inner wall member 2 is disposed in the outer wall member 3 with the space portion 4 therebetween. The opening end portions 2a and 3a of the inner wall member 2 and the outer wall member 3, respectively, are integrated by welding to produce a container having a double-wall structure including the space portion. After this, the space portion 4, which is formed between the inner wall member 2 and the outer wall member 3, is evacuated to provide a predetermined vacuum degree of 1.332×10⁻¹ Pa or less, and the hole used for evacuation is sealed to obtain desired metallic evacuated heat insulating layer body 1. The evacuation process and the vacuum sealing process can be readily achieved using a conventional method for forming an evacuated space, for instance, by placing the integrated container having the double wall structure in a vacuum heating furnace to carry out a vacuum heating process to make the space portion 4 a vacuum of a predetermined degree and then sealing the evacuation hole formed in the outer wall member 3, or by connecting an evacuation device to the evacuation hole formed in the outer wall member 3 to carry out an evacuation process and seal the evacuation hole when a desired degree of vacuum is achieved.

Assembling Process for the Heat Insulating Container 10

Next, after the above-mentioned heat insulating layer body 1 is placed between the inside container part 11 made of a synthetic resin and the outside container part 12 made of a synthetic resin so as to match their shapes and assemble, then, the opening end portion 11a of the inside container part 11 is integrated with the opening end portion 12a of the outside container part 12 using a bonding means, such as welding, to obtain the desired heat insulating container 10 of the present invention.

Note that the integration process can also be achieved by a screwing method other than the bonding by welding.

Also, as another assembling method, it is possible to adapt a so-called insert molding process in which the metallic heat insulating layer body 1 made in advance is placed at a predetermined position of a die for a synthetic resin having a desired shape, and a synthetic resin is introduced onto at least one of the inner surface and the outer surface of the heat insulating layer body 1 so that the synthetic resin makes close contact with the heat insulating layer body 1 to be unified with the heat insulating layer body 1.

Next, in order to confirm the physical and chemical characteristics of the heat insulating container according to the present invention, a heat insulating container having the structure shown in FIG. 1 was constructed. Also, conventional heat insulating containers were produced, as comparative examples, using a metal and a synthetic resin so as to have the same shape and size as the heat insulating container of the present invention, and these were compared by carrying out the following performance tests.

### EXAMPLE 1

A heat insulating container (A) having the technical specifications shown below was constructed as Example 1 of the present invention.

<Specifications of the Heat Insulating Container (A)>

| | |
|---|---|
| inner diameter of opening end portion | ca. 118.4 mm |
| 11a of inside container part 11: | |
| depth of inside container part 11 from | ca. 63 mm |
| opening end portion 11 a: | |
| volume: | ca. 300 cc |
| inside container part 11: | polypropylene (“CL5 138”, |
| | Chisso Corp.), 1.5 mm thickness |
| outside container part 12: | polypropylene (“CL5 138”, |
| | Chisso Corp.), 1.5 mm thickness |
| inner wall member 2: | stainless steel SUS 304, 0.2 mm |
| | thickness |
| outer wall member 3: | stainless steel SUS 304, 0.3 mm |
| | thickness |
| heat insulating layer body 1: | 3.0 mm width (inner size) of |
| | space portion 4 vacuum heat |
| | insulation (1.332 × 10⁻¹ Pa) |
| radiation preventing layer 7: | copper foil |
| total wall thickness of heat insulating | 6.5 mm |
| container (A): | |

### COMPARATIVE EXAMPLE 1

A heat insulating container (x), which included a conventional metallic double-wall structure to provide heat insulation property using a vacuum, having the technical specifications shown below was constructed as the heat insulating container of Comparative Example 1.

<Specifications of the Heat Insulating Container (x)>

| inner diameter of opening | ca. 118.4 mm |
|---|---|
| end portion of inside container | |
| part: | |
| depth of inside container part | ca. 63 mm |
| from opening end portion: | |
| volume: | ca. 300 cc |
| heat insulating medium | vacuum heat insulation (1.332 × 10⁻¹ Pa) |
| The above specifications are the same as those of the above-explained heat insulating container (A) according to Example 1 of the present invention. | |
| inside container part: | stainless steel SUS 304, 0.7 mm thickness |
| outside container part: | stainless steel SUS 304, 0.8 mm thickness |
| total wall thickness of heat | 4 mm |
| insulating container (x) having | |
| a metallic inner and outer | |
| double-wall structure: | |

### COMPARATIVE EXAMPLE 2

A heat insulating container (y), which included a conventional synthetic resin double-wall structure using a urethane material as a heat insulting material, having the technical specifications shown below was constructed as the heat insulating container of Comparative Example 2.

<Specifications of the Heat Insulating Container (y)>

| | |
|---|---|
| inner diameter of opening end portion of inside | ca. 118.4 mm |
| container part: | |
| depth of inside container part from opening end portion: | ca. 63 mm |
| volume: | ca. 300 cc |

The above specifications are the same as those of the above-explained heat insulating container (A) according to Example 1 of the present invention and the heat insulating container (x) of Comparative Example 1.

| | |
|---|---|
| inside container part: | polycarbonate, 2.0 mm thickness |
| outside container part 12: | polycarbonate, 2.5 mm thickness |
| total wall thickness of heat insulating | 12.5 mm |
| container (y) having a synthesized resin | |
| inner and outer double-wall structure: | |

The following tests were conducted in order to confirm the characteristics of the heat insulating container (A) of Example 1, the heat insulating container (x) of Comparative Example 1, and the heat insulating container (y) of Comparative Example 2.

The tests were performed by measuring the total weight of the three kinds of the heat insulating containers, i.e., the heat insulating container (A) of Example 1 according to the present invention, and the conventional heat insulating container (x) of Comparative Example 1 and the heat insulating container (y) of Comparative Example 2, respectively, and by performing a drop test (Test 1), a 100° C. environment exposure test (Test 2), a corrosion test (Test 3), and a heat insulation test (Test 4). The results of the tests are tabulated in Table 1 for comparison.

Test 1

The drop test of Test 1 was carried out using a drop tester, and 300 cc of water was poured in each of the heat insulating containers. Each of the containers was set at a height of 70 cm, and was dropped in an upright state. None of the heat insulating containers were damaged, and no particular problems arose when the containers were used afterwards.

Test 2

Then, in the 100° C. environment exposure test of Test 2, each heat insulating container was placed in a thermostat and was left for 1.5 hours. No particular expansion was occurred for the heat insulating container (A) of the present invention and the metallic heat insulating container (x). However, the inside container part of the heat insulating container (y) made of a synthetic resin using urethane as a heat insulating material of Comparative Example 2 expanded towards the inside thereof, and the expanded shape of the container did not return to the original shape after it was removed from the thermostat and cooled.

TABLE 1

| | Example 1 | | Comp. Example. 1 | | Comp. Example. 2 | |
|---|---|---|---|---|---|---|
| | Heat insulating | | Metallic heat | | Synthetic resin heat | |
| | container (A) of | | insulating container | | insulating container | |
| | present invention | | (x) | | (y) | |
| Weight(g) | 180 | ◯ | 250 | X | 160 | ◯ |
| Drop test | No damage | ◯ | No damage | ◯ | No damage | ◯ |
| 100° C. environment | No expansion | ◯ | No expansion | ◯ | Expansion | X |
| exposure test | | | | | | |
| Corrosion test | Excellent | ◯ | Partial rusting | X | Excellent | ◯ |
| When washed | No floating | ◯ | No floating | ◯ | Floating | X |
| Heat insulation ° C. | 70° C. | ◯ | 64° C. | X | 68° C. | Δ |

| | | | |
|---|---|---|---|
| Heat insulating | Vacuum insulation | Vacuum insulation | Urethane foaming |
| medium | | | insulation |

◯: Excellent
Δ: Good
X: No good

Test 3

In the corrosion test of Test 3, the whole heat insulating container was immersed in a 1/60 wt % solution (salinity of about 1.3%) of Japanese hotchpotch soup stock, and the container was left for one week. Three heat insulating containers were used for each Example and Comparative Example to obtain the evaluation. As for the metallic heating insulating container (x) of Comparative Example 1, a polishing residue remained in portions of the surface where the polishing was coarsely carried out, and rusting occurred. Also, small rust was generated from a portion where treatment for welding was not sufficient at the welded opening portion of the container. On the other hand, no particular problems were caused for the heat insulating container (A) of Example 1 of the present invention and the heat insulating container (y) made of a synthetic resin of Comparative Example 2.

Test 4

Finally, in the heat insulation test of Test 4, after each heat insulating container was placed in a thermostat, the temperature of which was set at 20° C., for more than one hour, hot water at 95±1° C. was poured in the heat insulating container, and the container was covered with a heat insulating cover made of Styrofoam and was returned to the thermostat at 20° C. The temperature of the hot water after one hour was measured to evaluate the heat insulating performance of each of the containers. The temperature of hot water was 70° C. for the heat insulating container (A) of the present invention, 64° C. for the metallic heat insulating container (x), and 68° C. for the heat insulating container (y) made of a synthetic resin. Accordingly, it was found out that the heat insulating container (A) of the present invention has the highest heat insulating performance.

### EXAMPLE 2

Next, the buoyancy of the heat insulating container of the present invention shown in FIG. 1 was confirmed by constructing three kinds of heat insulating containers (B), (C), and (D) whose size was varied as follows. Note that stainless steel SUS 304 was used for the inner wall member 2 and the outer wall member 3, and ABS (SR-H-35, a product of Denki Kagaku Kogyo K. K.) was used as a synthetic resin for the inside container part 11 and the outside container part 12. Also, copper foil was used for the radiation preventing layer 7.

Heat Insulating Container (B)

| | |
|---|---|
| inner diameter of inner wall member 2: | ca. 121.0 mm, thickness 0.3 mm |
| outer diameter of outer wall member 3: | ca. 136.0 mm, thickness 0.3 mm |
| inner diameter of inside container | ca. 119.4 mm, thickness 1.5 mm |
| part 11: | |
| outer diameter of outside container | ca. 142.0 mm, thickness 1.5 mm |
| part 12: | |
| width of space portion 4 of heat | 4.0 mm (inner size) |
| insulating layer body 1: | |
| depth of inside container part 11: | ca. 63 mm |
| total weight: | 227.5 g |
| volume of heat insulating container (B): | 223.0 cc |
| [total weight]/[volume of heat insulating | 1.02 g/cc |
| container (B)]: | |

Heat Insulating Container (C)

| | |
|---|---|
| inner diameter of inner wall member 2: | ca. 121.0 mm, thickness 0.2 mm |
| outer diameter of outer wall member 3: | ca. 136.0 mm, thickness 0.3 mm |
| inner diameter of inside container | ca. 119.4 mm, thickness 1.5 mm |
| part 11: | |
| outer diameter of outside container | ca. 142.0 mm, thickness 1.5 mm |
| part 12: | |
| width of space portion 4 of heat | 4.0 mm (inner size) |
| insulating layer body 1: | |
| depth of inside container part 11: | ca. 63 mm |
| total weight: | 208.4 g |
| volume of heat insulating container (C): | 220.5 cc |
| [total weight]/[volume of heat insulating | 0.94 g/cc |
| container (C)]: | |

Compared to the above-mentioned specifications for the structure of the heat insulating container (B), the thickness of the inner wall member 2 of the heat insulating container (C) was reduced by 0.1 mm. The other elements were not changed. As a result, the degree of decrease in the total weight became larger than the decrease in the volume, and the specific gravity thereof was less than 1 g/cc. Accordingly, the container could not be immersed in water.

Heat Insulating Container (D)

| | |
|---|---|
| inner diameter of inner wall member 2: | ca. 122.0 mm, thickness 0.2 mm |
| outer diameter of outer wall member 3: | ca. 136.0 mm, thickness 0.3 mm |
| inner diameter of inside container | ca. 118.4 mm, thickness 1.5 mm |
| part 11: | |
| outer diameter of outside container | ca. 142.0 mm, thickness 1.5 mm |
| part 12: | |
| width of space portion 4 of heat | 2.5 mm (inner size) |
| insulating layer body 1: | |
| depth of inside container part 11: | ca. 63 mm |
| total weight: | 203.6 g |
| volume of heat insulating container (D): | 177.6 cc |
| [total weight]/[volume of heat insulating | 1.15 g/cc |
| container (C)]: | |

In the above-mentioned specifications for the structure of the heat insulating container (C), the width of the space portion 4 of the heat insulating layer body 1 of the heat insulating container (D) was reduced by 1.5 mm to be 2.5 mm. As a result, the volume of the heat insulating container was reduced so as to increase the specific gravity thereof, to be greater than 1 g/cc. Accordingly, it was possible to immerse the container in water.

As explained above, although the buoyancy of the heat insulating container varied in Example 2 of the present invention in accordance with the specifications thereof, it was possible to make the specific gravity thereof greater than 1 by suitably adjusting the thickness of the inner wall member 2 and the thickness of the heat insulating layer body 1 which is made of a metal. Also, it was confirmed that the specific gravity can be adjusted without adversely affecting the heat insulating capacity thereof by making the thickness of the opening portion 11a of the inner wall member 11 made of a metal be 0.3 mm or less.

### EXAMPLE 3

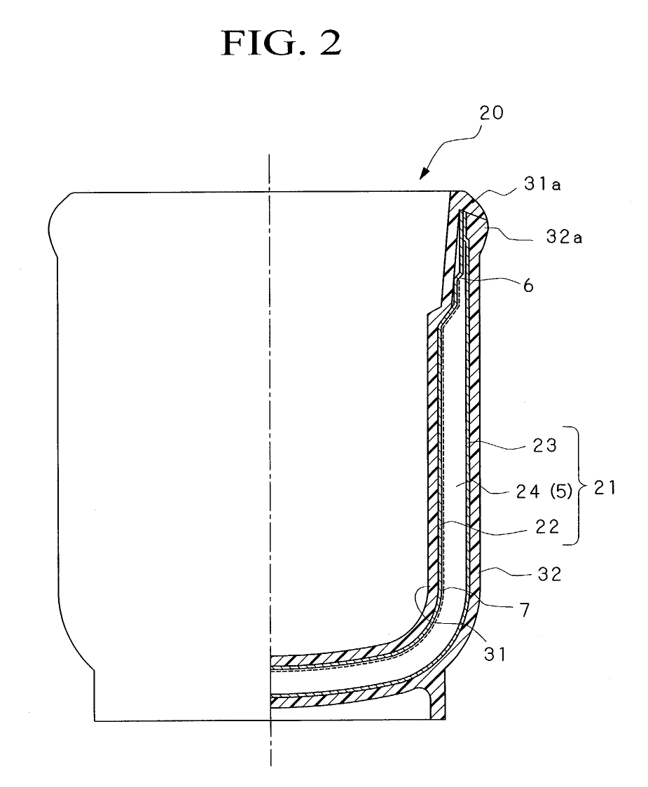

Also, as Example 3, an inner wall member 22 and an outer wall member 23 of a cup shape, which are made of a metal, such as stainless steel, were integrated with a space portion 24 therebetween as shown in FIG. 2, and the space portion 24 was evacuated to form an evacuated space 5 to produce a heat insulating layer body 21 of a cup shape. An inside container part 31 and an outside container part 32 made of a synthetic resin were placed so as to surround the heat insulating layer body 21. For this heat insulating container, the specifications of the inner wall member 22 and the outer wall member made of a metal were varied to produce three kinds of heat insulating containers (E), (F), and (G) using the same method, and the change in buoyancy thereof was confirmed.

Note that the inner wall member 22 and the outer wall member 23 were formed using SUS 304, and the inside container part 31 and the outside container part 32 were formed using polycarbonate (panlight L-1225T, a product of Teijin Limited). Also, copper foil was disposed at the inner surface of the inner wall member 22 as a radiation preventing layer 7.

Heat Insulating Container (E) in Cup Shape

| | |
|---|---|
| inner diameter of inner wall member 22: | ca. 54 mm, thickness 0.3 mm |
| outer diameter of outer wall member 23: | ca. 62.2 mm, thickness 0.3 mm |
| inner diameter of inside container | ca. 50.0 mm, thickness 1.5 mm |
| part 31: | |
| outer diameter of outside container | ca. 66.2 mm, thickness 1.5 mm |
| part 32: | |
| width of space portion 24 of heat | 4.0 mm (inner size) |
| insulating layer body 21: | |
| total clearance of inside and outside | 0.5 mm |
| container parts and heat insulating | |
| layer body 21: | |
| depth of inside container part: | 80 mm |
| total weight: | 135.4 g |
| volume of cup shape heat insulating | 129.6 cc |
| container (E): | |
| [total weight]/[volume of cup shape heat | 1.04 g/cc |
| insulating container (E)] | |

Heat Insulating Container (F) in Cup Shape

| | |
|---|---|
| inner diameter of inner wall member 22: | ca. 54 mm, thickness 0.2 mm |
| outer diameter of outer wall member 23: | ca. 62.0 mm, thickness 0.3 mm |
| inner diameter of inside container | ca. 50.0 mm, thickness 1.5 mm |
| part 31: | |
| outer diameter of outside container | ca. 66.0 mm, thickness 1.5 mm |
| part 32: | |
| width of space portion 24 of heat | 4.0 mm (inner size) |
| insulating layer body 21: | |
| total clearance of inside and outside | 0.5 mm |
| container parts and heat insulating | |
| layer body 21: | |
| depth of inside container part: | 80 mm |
| total weight: | 122.9 g |
| volume of cup shape heat insulating | 127.8 cc |
| container (F): | |
| [total weight]/[volume of cup shape heat | 0.96 g/cc |
| insulating container (F)] | |

In the above-mentioned specifications of the structure of the cup shape heat insulating container (E), the thickness of the metallic inner wall member of the heat insulating container (F) was reduced by 0.1 mm. The other elements were not changed. As a result, the total weight of the container was decreased, and the specific gravity thereof became less than 1 g/cc. Accordingly, the container could not be immersed in the water.

Heat Insulating Container (G) in Cup Shape

| | |
|---|---|
| inner diameter of inner wall member 22: | ca. 54 mm, thickness 0.2 mm |
| outer diameter of outer wall member 23: | ca. 59.0 mm, thickness 0.3 mm |
| inner diameter of inside container | ca. 50.0 mm, thickness 1.5 mm |
| part 31: | |
| outer diameter of outside container | ca. 63.0 mm, thickness 1.5 mm |
| part 32: | |
| width of space portion 24 of heat | 2.5 mm (inner size) |
| insulating layer body 21: | |
| total clearance of inside and outside | 0.5 mm |
| container parts and heat insulating | |
| layer body 21: | |
| depth of inside container part: | 80 mm |
| total weight: | 117.9 g |
| volume of cup shape heat insulating | 103.0 cc |
| container (G): | |
| [total weight]/[volume of cup shape heat | 1.14 g/cc |
| insulating container (G)] | |

In the above-mentioned specifications of the structure of the heat insulating container (F), the width of the space portion of the heat insulating layer body of the cup shape heat insulating container (G) was reduced by 1.5 mm to be 2.5 mm. As a result, the volume of the heat insulating container was reduced so as to increase the specific gravity thereof to be greater than 1 g/cc. Accordingly, it became possible to immerse the container in water.

As explained above, when the six kinds of heat insulating containers according to the present invention were immersed in water, it was confirmed that the heat insulating container (B), the heat insulating container (D), the cup shape heat insulating container (E), and the cup shape heat insulating container (G) could be immersed in water.

Then, as explained above, when the thickness of the inner wall member was set to be 0.3 mm or less, and the width of the space portion of the heat insulating layer body is suitably narrowed to 4 mm or less, and it became possible to immerse the heat insulating containers of the present invention in water, so that they did not float, and the workability thereof during the washing process was improved.

### EXAMPLE 4

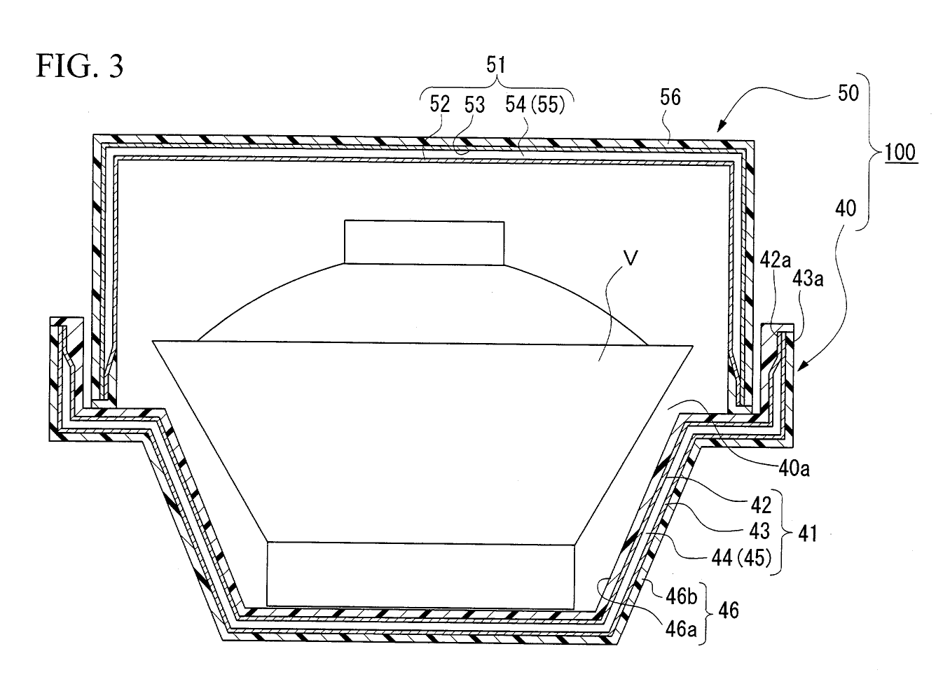

Next, as a heat insulating container according to Example 4 of the invention, a heat insulating and retaining storage container 100 as shown in FIG. 3, which is suitable for holding and carrying food which is contained in non-insulated general tableware V, was manufactured using an insertion molding method. Note that in FIG. 3, elements which are the same as those in FIG. 1 are indicated using the same numerals, and the explanation thereof will be omitted.

The heat insulating and retaining storage container 100 includes a storage container part 40 having an upper opening portion, in which the container V, such as tableware, is placed, and a cover member 50 which covers an opening portion 40a.

The storage container part 40 includes an inner wall member 42 in a container shape, which is made of a metal, such as stainless steel, and an outer wall member 43 in a container shape, which has a similar shape to the inner wall member 42 but somewhat larger, and they are disposed with a space portion 44 therebetween. Opening end portions 42a and 43a of the inner wall member 42 and the outer wall member 43, respectively, are welded to be integrated, and synthetic resin layers 46a and 46b are integrated so as to cover the inner surface and outer surface of the heat insulating layer body 41 including a vacuum space 45 formed by evacuating the space portion 44.

In the manufacturing process, the heat insulating layer body 41 in a container shape made of a metal was prepared in advance using the same method as in Example 1. Then, the metallic heat insulating layer body 41 was placed at a predetermined position of a die for a synthetic resin having a desired shape, and using an insertion molding process in which a synthetic resin is introduced to the die, the synthetic resin layers 46a and 46b were formed on the inner and the outer surfaces, respectively, of the heat insulating layer body 41 in a desired manner. Note that in the insertion molding process, the synthetic resin 46 was first introduced to the outer surface of the heat insulating layer body 41 to form the synthetic resin layer 46b for the outer surface, and then the synthetic resin 46 was introduced to the inner surface of the heat insulating layer body 41 to form the synthetic resin layer 46a on the inner surface of the heat insulating layer body 41 in a desired manner.

Also, the cover member 50 is formed so as to engage with the above-mentioned opening portion 40a of the storage container part 40. The cover member 50 includes metallic inner and outer wall members 52 and 53 which are integrated so as to contain space portion 54 between the inner and the outer wall members 52 and 53 to form a double-walled structure, and a synthetic resin layer 56 which covers the outer surface of a heat insulating layer body 51 including the space portion 54 as a vacuum layer 55. Note that since no load is applied to the inner surface of the cover member 50, a structure is adopted in which the synthetic resin layer is not formed on the inner surface of the heat insulating layer body 51, and the metallic inner wall member 52 is exposed.

When the cover member is produced, similar to the production of the above-mentioned storage container part 40, after the metallic heat insulating layer body 51 was produced in a desired shape, the synthetic resin layer 56 was formed on the outer surface of the metallic heat insulating layer body 51 by the insertion molding method.

Note that the synthetic resins 46 and 56 used for the heat insulating and retaining storage container 100 were polycarbonate, and the thickness of the synthetic resin layers 46 and 56 of the storage container 40 and the cover member 50, respectively, were 2.3 mm for the outer surface synthetic resin layers 46b and 56, and 2.2 mm for the inner surface synthetic resin layer 46a.

Also, the material used for the metallic heat insulating layer bodies 41 and 51 was stainless steel, and the thickness of the inner wall members 42 and 52 was 0.2 mm, and the thickness of the outer wall members 43 and 53 was 0.3 mm.

Moreover, the width of the space portion 44 or 54 of the vacuum heat insulating layer was 2.0 mm.

The heat insulating and retaining storage container 100 manufactured in Example 4 had the shape shown in FIG. 3, and the specifications for the storage container 40 and that for the cover member 50 are as follows.

<Specifications of the Storage Container Part 40>

| top opening of storage container part 40: | outer diameter 164.4 mm |
|---|---|
| | inner diameter 150.0 mm |
| opening at stepped portion of storage container part | outer diameter 124.0 mm |
| 40: | inner diameter 114.2 mm |
| bottom of storage container part 40: | outer diameter 89.9 mm |
| | inner diameter 80.0 mm |
| height of storage container part 40: | overall height 69.8 mm |
| depth of storage container part 40: | top-stepped portion 20.0 mm |
| | stepped portion-bottom 42.8 mm |
| weight of storage container part 40: | 386 g |
| volume of storage container part 40: | 290 cm³ |
| specific gravity of storage container part 40: | 1.33 |

<Specifications of the Cover Member 50>

| size of cover member 50: | outer diameter 144.0 mm |
|---|---|
| | inner diameter 134.0 mm |
| | overall height 58.2 mm |
| | inner surface height 53.2 mm |
| weight of cover member 50: | 276 g |
| volume of cover member 50: | 192 cm³ |
| specific gravity of cover member 50: | 1.43 |

As indicated above, in the heat insulating and retaining storage container 100 of Example 4, the specific gravity of both the storage container part 40 and of the cover member 50 were more than 1, and hence, it became possible to immerse the container in water during the washing process to easily carry out an washing process, and the efficiency in the washing process was improved.

Also, in the above-mentioned Example 4, if a radiation preventing layer including metal foil or a metal layer made of, for instance, aluminum, is provided with the vacuum heat insulating layers 45 and 55 in order to shut out radiation heat as in Example 1, the heat insulating property of the container can be further improved.

Moreover, since the formation of the synthetic resin layers 46a, 46b, and 56 on the heat insulating layer body 41 and 51 were carried out using the insertion molding method, the degree of contact thereof was increased, and heat insulating containers or the cover members having excellent appearance and durability were obtained.

Note that although a heat insulating and retaining storage container for holding only one container V, such as tableware, was used as an example in Example 4, the heat insulating and retaining storage container can be suitably used as a container for school meals or a container for delivery by modifying its structure to accommodate various types of tableware, etc., for various foods.

Industrial Applicability

Since the heat insulating container of the present invention includes a vacuum heat insulating layer body made of a metal, and an inside container part and an outside container part are integrally formed so as to cover the heat insulating layer body, the strength of the container is not adversely affected, and a sufficient heat insulating property can be obtained by decreasing the thickness of the heat insulating layer body if the heat insulating layer body is formed of a metal having a large heat conductivity. In addition, since the volume of the space portion of the heat insulating layer body can be decreased, efficiency in the available volumetric space can be increased to improve the heat insulating property.

Also, since a metal is used for the heat insulating layer body, the specific gravity of the heat insulating container can be made 1 or greater, and hence, the container does not float in the water and can be immersed in the water when placed in a washing bath during a washing process, and it becomes possible to carry out the washing process in an efficient manner using an automated washing device.

Moreover, since the inside container part and the outside container part are made of a synthetic resin, the container does not become hot when hot food is placed in the container. Accordingly, it becomes possible for a user of the container to put his lips to the opening portion of the container to take food or drink in the container without being burned. Furthermore, a design can be applied to the outer surface of the container by printing, etc., and a heat insulating container having an excellent appearance can be manufactured.

What is claimed is:

1. A heat insulating container, comprising: a heat insulating layer body which is formed by a metallic inner wall member having a container shape, and a metallic outer wall member having a container shape, end portions of the inner wall member and end portions of the outer wall member being integrally bonded so as to have a vacuum space portion between the inner wall member and the outer wall member; and a synthetic resin which covers at least one of an inner surface and an outer surface of the heat insulating layer body and is integrated with the heat insulating layer body.

2. A heat insulating container according to claim 1, wherein the synthetic resin, which covers at least one of the inner surface and the outer surface of the metallic heat insulating layer body and integrated with the heat insulating body, covers both the inner surface and the outer surface of the metallic heat insulating layer body, and each end portion thereof is airtightly bonded and integrated.

3. A heat insulating container according to claim 1, wherein the synthetic resin, which covers at least one of the inner surface and the outer surface of the metallic heat insulating layer body and is integrated with the heat insulating layer body, is formed on at least one of the inner surface and the outer surface of the heat insulating layer body and integrated therewith using an insertion molding method.

4. A heat insulating container according to any one of claims 1-3, wherein the specific gravity of the heat insulating container is 1 or more.

5. A heat insulating container according to claim 1, wherein a width of the space portion of the heat insulating layer body is 4 mm or less.

6. A heat insulating container according to claim 1, wherein a thickness of an opening portion of the inner wall member of the heat insulating layer body is 0.3 mm or less.

7. A heat insulating container according to claim 1, further comprising a multi-bent stepped portion provided at the inner wall member of the heat insulating layer body facing an opening portion of an inside container part of the heat insulating container.

8. A heat insulating container according to claim 7, wherein the length of a wall portion forming the stepped portion of the inner wall member of the heat insulating layer body facing the opening portion of the inside container part of the heat insulating container is 20 mm or longer.

9. A heat insulating container according to claim 1, further comprising a concave portion provided at the opening portion of the inside container part of the heat insulating container, the concave portion being formed so as to retract towards a heat insulating layer side.
